(19) United States
(12) Patent Application Publication
(10) Pub. No.: US 2016/0297994 A1
(43) Pub. Date: Oct. 13, 2016

(54) CURABLE BENZOXAZINE-BASED PHENOLIC RESINS AND COATING COMPOSITIONS THEREOF

(71) Applicant: Eastman Chemical Company, Kingsport, TN (US)

(72) Inventors: Thauming Kuo, Kingsport, TN (US); Phillip Bryan Hall, Jonesborough, TN (US)

(73) Assignee: EASTMAN CHEMICAL COMPANY, Kingsport, TN (US)

(21) Appl. No.: 14/683,282

(22) Filed: Apr. 10, 2015

(51) Int. Cl. C09D 179/04; C09D 167/02

(52) U.S. Cl. CPC C09D 179/04; C09D 167/02

(57) ABSTRACT

A thermosetting coating composition comprising: (a) a polymer selected from a polyester, a polycarbonate, a polyamide, and an epoxy and (b) a curable benzoxazine-based phenolic resin comprising the reaction product of: (i) a phenol compound, (ii) an aldehyde, and (iii) a polyamine having at least one primary amine and at least one secondary amine.

### FIELD OF THE INVENTION

The present invention relates to thermosetting coating composition comprising polyester and a curable benzoxazine-based phenolic resin. The phenolic resin is a reaction product of phenol, aldehyde, and a polyamine having a primary and secondary amine moiety. A variety of functional polyesters can be used with the phenolic resin to yield coating films with improved solvent resistance, lower cure times and temperatures.

### BACKGROUND OF THE INVENTION

Metal containers are commonly used for food and beverage packaging. The containers are typically made of steel or aluminum. A prolonged contact between the metal and the filled product can lead to corrosion of the container. To prevent direct contact between the filled product and the metal interior, a coating is typically applied to the interior of the food and beverage cans. In order to be effective, such a coating must have adequate properties that are needed for protecting the packaged products, such as adhesion, corrosion resistance, chemical resistance, flexibility, stain resistance, and hydrolytic stability. Moreover, the coating must be able to withstand processing conditions during can fabrication and food sterilization. Coatings based on a combination of epoxy and phenolic resins are known to be able to provide a good balance of the required properties and are most widely used. There are industry sectors moving away from food contact polymers made with bisphenol A (BPA) and bisphenol A diglycidyl ether (BADGE), which are the building blocks of the epoxy resins. Thus, there exists a desire for the replacement of epoxy resin used in interior can coatings.

Polyester has been of particular interest to the coating industry to be used as a replacement for epoxy resin because of its comparable properties such as flexibility and adhesion. It is known by one skilled in the art that crosslinking between common polyester and phenolic resin is too poor to provide adequate properties for use in interior can coatings. Specifically, conventional polyesters having hydroxyl functionalities are not reactive enough with phenolic resins under curing conditions to provide adequate crosslinking density, resulting in a coating that lacks good solvent resistance.

One way to overcome this crosslinking deficiency is to use a polyester having, for example a number average molecular weight greater than 5000 g/mole, with a glass transition temperature (Tg) generally greater than 50° C., which can impart improved coating properties by virtue of forming an interpenetrating polymer network with phenolic resin upon curing. This approach can be improved further by providing an improved curable phenolic resin. Conventional phenolic resins used with polyesters are based on the reaction product of a phenol compound and formaldehyde. Such a phenolic resin is curable by itself upon heating. However, the phenolic film is negatively impacted by being either highly brittle or wrinkled and loosely attached to the substrate. Such phenolic resins further exhibits poor interpenetrating polymer network formed with the polyester.

Benzoxazine-based phenolic resin (or benzoxazine) is typically prepared by combining a phenolic compound, an aliphatic aldehyde, and a primary amine (RNH₂) depicted in the reaction scheme below:

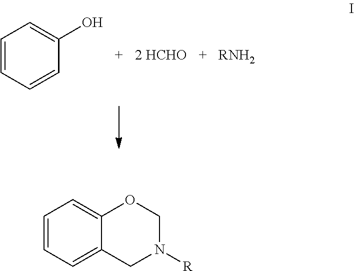

The reaction product thus obtained typically is a viscous resin containing benzoxazine small molecules and oligomers via ring opening addition reaction. Such a resin is capable of undergoing further polymerization upon heating to yield a crosslinked product similar to phenolic resins. The curing usually requires prolonged (hours) heating at a temperature greater than 200° C. The resulting thermoset material is known to exhibit excellent heat resistance, flammability resistance, low moisture absorption, impact toughness, and good mechanical properties. It can be used as a material for composites, surface bonding, or repairing solution in areas such electronics and aircraft. The technology, however, has little use as a binder resin for surface coatings due to its exceptionally high curing temperatures.

Accordingly, there still exists a need for a phenolic resin that is capable of forming coating films with improved properties such as appearance, adhesion, and impact resistance. It is also desirable for such phenolic resin to have self film forming capabilities as well as film forming capabilities with functionalized polymers such as polyesters, polycarbonates, polyamides, and epoxies.

### SUMMARY OF THE INVENTION

Briefly, the present invention is a thermosetting coating composition comprising: (a) a polymer selected from a polyester, a polycarbonate, a polyamide, and an epoxy and (b) a curable benzoxazine-based phenolic resin comprising the reaction product of: (i) a phenol compound, (ii) an aldehyde, and (iii) a polyamine having at least one primary amine and at least one secondary amine.

Another aspect of the present invention is to provide a coating composition comprising: (a) a polyester having a functional moiety selected from the group consisting of hydroxyl, phenolic hydroxyl, acetoacetate, carbamate, amino, maleimide, diene and mixtures thereof, wherein if the polyester does not have any of the aforementioned functionalities then the carboxyl number, as determined by the acid number, is to be greater than 20 mg KOH/g and (b) a curable benzoxazine-based phenolic resin comprising the reaction product of: (i) a phenol compound, (ii) an aldehyde, and (iii) a polyamine having at least one primary amine and at least one secondary amine.

It is an object of the present invention is to provide a coating composition based on a polyester and the benzoxazine-based phenolic resin having desirable coating properties such as solvent resistance, water resistance, chemical resistance, and impact resistance.

These and other objects and advantages of the present invention will become more apparent to those skilled in the art in view of the following description. It is to be understood that the inventive concept is not to be considered limited to the constructions disclosed herein but instead by the scope of the appended claims.

### DETAILED DESCRIPTION OF THE INVENTION

In accordance with one aspect of the present invention, it was surprisingly found that a benzoxazine compound based on a polyamine having at least one primary amine and at least one secondary amine is curable at lower temperatures than those with only a primary amine. Advantageously, a benzoxazine of the present invention can be cured at lower temperatures of from about 160° C. to 200° C. Moreover, such benzoxazine compounds are capable of self-crosslinking to for a film coating having excellent appearance, adhesion, and solvent resistance. Unlike previously known benzoxazines, a catalyst is not required for curing. Although not to be bound to any theory, it is believed that the secondary amino group reacts with an aldehyde, such as formaldehyde, to form a hydroxymethyl group on the amine nitrogen. Such a hydroxymethyl-amino moiety is known to be particularly reactive toward a nucleophile, which is thought to be generated during heating facilitating the ring opening polymerization of the benzoxazine. This results in a greatly improved crosslinking at lower temperatures. It is believed that the formation of hydroxymethyl-amino moiety can be illustrated in the following Reaction Scheme II, where a benzoxazine is prepared by reacting m-cresol, formaldehyde, and diethylenetriamine at a molar ratio of 2:5:1.

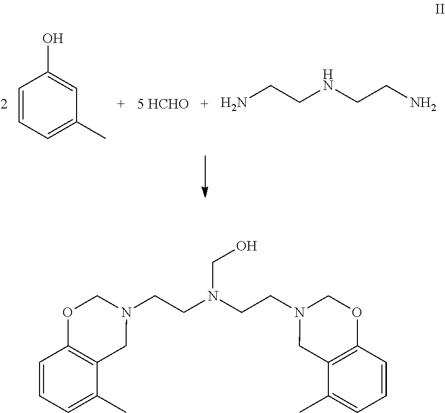

The benzoxazines may be prepared by reacting a phenolic compound, an aliphatic aldehyde and an amine compound generally in the presence of a solvent and may include the use of a catalyst. Desirably, the solvent is an organic solvent such as, for example, toluene, xylene, butanol, propanol, ethanol, or methanol. For reactions involving formaldehyde, its aqueous solution, formalin, or its polymeric compound, paraformaldehyde, can be used. When formalin is used in the reaction, an alcohol solvent is preferred. The reaction temperature can range from about 60° C. to about 150° C. Desirably, the water condensate resulting from the reaction is removed during the reaction to facilitate the reaction. The phenolic resin thus obtained can be isolated neat by removing the solvent after the reaction, or it can be isolated as a solution in the solvent.

In preparing the benzoxazine-based phenolic resin, the equivalent ratio of phenolic hydroxyl/primary amine ranges from about 0.8 to about 1.5 and the equivalent ratio of aldehyde/amine hydrogen ranges from about 0.5 to about 1.2, where the amine hydrogen is the hydrogen atom on the amine groups including primary and secondary. For example, when a benzoxazine is made using m-cresol as the phenol, formaldehyde as the aldehyde and diethylenetriamine as the amine with a primary and secondary amine, at a molar ratio of 2/5/1, the equivalent ratio of phenolic hydroxyl to primary amine is 2/2=1, and the equivalent ratio of aldehyde/amine hydrogen is 5/5=1.

Desirably, the equivalent ratio of phenolic hydroxyl/primary amine is about 1 and the equivalent ratio of aldehyde/amine hydrogen ranges from about 0.8 to about 1.

Phenolic compounds suitable for use in preparing the benzoxazine-based phenolic resin include mono- and poly-phenol compounds. Non-limiting examples of mono-phenol compounds include unsubstituted and substituted phenol. Examples of mono-functional phenols include phenol, cresol, 2-bromo-4-methylphenol, 2-allyphenol, and 4-aminophenol, dihydroxybenzenes such as resorcinol and catechol, or trihydroxybenzenes such as hydroxyquinol and phloroglucinol. Non-limiting examples of meta-substituted phenols include m-cresol, m-ethylphenol, m-propylphenol, m-butylphenol, m-octylphenol, m-phenylphenol, m-alkoxyphenol, 3,5-xylenol, 3,5-diethyl phenol, 3,5-dibutyl phenol, 3,5-dialkylphenol, 3,5-dicyclohexyl phenol, 3,5-dimethoxy phenol, 3-alkyl-5-alkyoxy phenol, and mixtures thereof.

The aryl ring of the phenolic compound may be a phenyl ring or may be selected from naphthyl, biphenyl, phenanthryl or anthracyl. Suitable examples of poly-phenol compounds include 2,2-bis(4-hydroxyphenyl)propane (bisphenol A), 2,2-bis(4-hydroxyphenyl)butane (bisphenol B), bis(4-hydroxyphenyl)methane (bisphenol F), 1,1-bis(4-hydroxyphenyl)ethane (bisphenol E), bis(4-hydroxyphenyl)sulfone (bisphenol S), 1,1-bis(4-hydroxyphenyl)-cyclohexane (bisphenol Z), and mixtures thereof.

Substituted phenols desirably have substituents at the meta-, para-, or 3,5-positions. Non-limiting examples of substituents include alkyl, alkoxy, aryl, aryloxy, carboxyl, halide and combinations thereof. Desirably, at least one of the positions ortho to the hydroxyl group is unsubsituted to facilitate ring formation.

The aldehyde used in preparing the benzoxazine-based phenolic resin is represented by the general formula R—CHO, where R is hydrogen or a hydrocarbon group having 1 to 12 carbon atoms which can be linear, branched, cyclic or aromatic, saturated or unsaturated. Suitable non-limiting examples include formaldehyde, acetaldehyde, butryaldehyde, propionaldehyde, furfuraldehyde, benzaldehyde and mixtures thereof.

The polyamines used in preparing the benzoxazine-based phenolic resin are those having at least one primary amine and at least one secondary amine. The polyamine desirably is represented by the general formula: H₂N-A-[NH—B]ₙ—NH₂, where A and B are independently selected from linear or branched hydrocarbon radicals having from 2 to 4 carbon atoms; n is an integer from 1 to 4; each B in the repeating unit —[NH—B]— are independent and may have different numbers of carbon atoms of from 1 to 15; or from 1 to 14; or from 1 to 13 or from 1 to 12; or from 1 to 11; or from 1 to 10; or from 1 to 9; or from 1 to 8; or from 1 to 7; or from 1 to 6; or from 1 to 5; or from 1 to 4; or from 1 to 3; or from 2 to 15; or from 2 to 14; or from 2 to 13 or from 2 to 12; or from 2 to 11; or from 2 to 10; or from 2 to 9; or from 2 to 8; or from 2 to 7; or from 2 to 6; or from 2 to 5; or from 2 to 4; or from 2 to 3; or from 3 to 15; or from 3 to 14; or from 3 to 13 or from 3 to 12; or from 3 to 11; or from 3 to 10; or from 3 to 9; or from 3 to 8; or from 3 to 7; or from 3 to 6; or from 3 to 5; or from 3 to 4; or from 4 to 15; or from 4 to 14; or from 4 to 13 or from 4 to 12; or from 4 to 11; or from 4 to 10; or from 4 to 9; or from 4 to 8; or from 4 to 7; or from 4 to 6; or from 4 to 5; or from 5 to 15; or from 5 to 14; or from 5 to 13 or from 5 to 12; or from 5 to 11; or from 5 to 10; or from 5 to 9; or from 5 to 8; or from 5 to 7; or from 5 to 6; or from 6 to 15; or from 6 to 14; or from 6 to 13 or from 6 to 12; or from 6 to 11; or from 6 to 10; or from 6 to 9; or from 6 to 8; or from 6 to 7; or from 7 to 15; or from 7 to 14; or from 7 to 13 or from 7 to 12; or from 7 to 11; or from 7 to 10; or from 7 to 9; or from 7 to 8; or from 8 to 15; or from 8 to 14; or from 8 to 13 or from 8 to 12; or from 8 to 11; or from 8 to 10; or from 8 to 9; or from 9 to 15; or from 9 to 14; or from 9 to 13 or from 9 to 12; or from 9 to 11; or from 9 to 10; or from 10 to 15; or from 10 to 14; or from 10 to 13 or from 10 to 12; or from 10 to 11; or from 11 to 15; or from 11 to 14; or from 11 to 13 or from 11 to 12; or from 12 to 15; or from 12 to 14; or from 12 to 13; or from 13 to 15; or from 13 to 14.

Desirably, the polyamine is selected from diethylenetriamine, tetraethylenepentamine, bis(hexamethylene)triamine, H₂N—(CH₂)₄—NH—(CH₂)₃—NH₂ (spermidine), and H₂N—(CH2)₃—NH—(CH₂)₄—NH—(CH₂)₃—NH₂ (spermine).

Many of the compounds can be obtained or are commercially available from general chemical suppliers such al Aldrich Chemical Company, Milwaukee, Wis.; Pfaltz and Bauer, Inc., Waterbury, Conn.; and Huntsman Chemical, Houston, Tex.

Advantageously, the benzoxazine-based phenolic resin of the invention is curable by itself to form coating film at a temperature greater than about 160° C. with or without a catalyst. Catalysts may be used to facilitate the ring-opening polymerization, which include catalysts known in the art for cationic polymerization such as Lewis acids and Bronsted acids and catalysts for anionic polymerization such as tertiary amines.

In addition to providing an improved self-curing property of benzoxazine, the hydroxymethyl-amino moiety can also react with other polymers having nucleophilic functionalities, such as hydroxyl, carboxyl, phenolic hydroxyl, acetoacetate, carbamate, and amino groups, and provide desirable coating properties of the polymer and the benzoxazine.

Another aspect of the invention is a composition comprising: (a) a polymer selected from a polyester, a polycarbonate, a polyamide, and an epoxy and (b) a curable benzoxazine-based phenolic resin comprising the reaction product of: (i) a phenol compound, (ii) an aldehyde, and (iii) a polyamine having at least one primary amine and at least one secondary amine. The polymer is hereinafter described as a polyester for sake of brevity although one skilled in the art would understand that the description herein is equally applicable to a polycarbonate, a polyamide, or an epoxy. Accordingly, the polyester has a residue functionality of hydroxyl, carboxyl, phenolic hydroxyl, acetoacetate, carbamate, amino, maleimide, or a diene group. Desirably, the polyester functionality is hydroxyl, phenolic hydroxyl, carboxyl, and combinations thereof. Advantageously, other polymers having electrophilic functionalities can also participate in the ring opening polymerization of benzoxazine by reacting with a phenoxide anion or a carbanion formed during the reaction. As used herein the term “residue(s)” or “residual” means the portion of a molecule in the polymer such as a polyester that remains after its reaction to form the curable resin and is intended to refer to both a single or plurality of such moieties.

The functional polyesters described in this invention are either modified from a conventional hydroxyl- or carboxyl-functional polyester wherein the desired phenolic hydroxyl, acetoacetate, carbamate, amino, maleimide, or a diene residue functionality is substituted in the place of the hydroxyl- or carbonyl-. Alternatively, the functional polyester may be synthesized using a monomer wherein the monomer residue in the polymer has the desirable functionality. The term “residue(s)” means the portion of a molecule in the polyester that remains after its reaction to form the curable polyester resin. For example, the acetoacetate- and maleimide-functional polyester can be synthesized by modifying from a hydroxyl functional polyester, the carbamate functional polyester from a carboxyl functional polyester, and the amino functional polyester from an unsaturated polyester, whereas the diene-functional polyesters are synthesized by incorporating a functional monomer, such as for example, furfuryl alcohol.

Polyesters having hydroxyl and/or carboxyl functionalities can be prepared by reacting a polyhydroxyl compound with a polycarboxyl compound. A polyester suitable for the invention is the reaction product of the components comprising: a) polyhydroxyl compound comprising: (i) a diol compound in an amount of 70 mole % to 100 mole %; and (ii) a polyhydroxyl compound having 3 or more hydroxyl groups in an amount of 0 to 30 mole %; and b) a polycarboxyl compound comprising polycarboxylic acid compounds, derivatives of polycarboxylic acid compounds, the anhydrides of polycarboxylic acids, and combinations thereof, wherein the mole % of diol is based on 100% of all moles of polyhydroxyl compounds and the mole % of carboxyl compounds is based on 100% of all moles of polycarboxyl compounds.

For purposes of calculating quantities, all compounds having at least one hydroxyl group are counted as polyhydroxyl compounds. Such compounds include, but are not limited to, mono-ols, diols, polyhydroxyl compounds having 3 or more hydroxyl groups, and for each of the foregoing, can be hydrocarbons of any chain length optionally containing ether groups such as polyether polyols, ester groups such as polyesters polyols, amide groups, amine groups, and anhydrides.

For example, one suitable polyester is disclosed in U.S. patent application having Ser. No. 14/524,509, filed on Oct. 27, 2014, the entire disclosure of which is incorporated herein by reference, discloses curable polyester resin having residues or moieties of polyhydroxyl compounds “(a)” of at least two types: i) 2,2,4,4-tetraalkylcyclobutane-1,3-diol (TACD) compounds, and ii) polyhydroxyl compounds other than TACD. More particularly, the diols “(a)(i)” have 2 hydroxyl groups and can be branched or linear, saturated or unsaturated, aliphatic or cycloaliphatic C₂-C₂₀ compounds, the hydroxyl groups being primary, secondary, and/or tertiary. The TACD compounds can be represented by the general structure below:

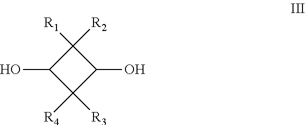

wherein R1, R2, R3, and R4 each independently represent an alkyl radical, for example, a lower alkyl radical having 1 to 8 carbon atoms; or 1 to 6 carbon atoms, or 1 to 5 carbon atoms, or 1 to 4 carbon atoms, or 1 to 3 carbon atoms, or 1 to 2 carbon atoms, or 1 carbon atom. The alkyl radicals may be linear, branched, or a combination of linear and branched alkyl radical. Desirably, the polyhydroxyl compounds are hydrocarbons and do not contain atoms other than hydrogen, carbon and oxygen. Examples of suitable diols “(a)(i)” include 2,2,4,4-tetramethylcyclobutane-1,3-diol, 2,2,4,4-tetraethylcyclobutane-1,3-diol, 2,2,4,4-tetra-n-propylcyclobutane-1,3-diol, 2,2,4,4-tetra-n-butylcyclobutane-1,3-diol, 2,2,4,4-tetra-n-pentylcyclobutane-1,3-diol, 2,2,4,4-tetra-n-hexylcyclobutane-1,3-diol, 2,2,4,4-tetra-n-heptylcyclobutane-1,3-diol, 2,2,4,4-tetra-n-octylcyclobutane-1,3-diol, 2,2-dimethyl-4,4-diethylcyclobutane-1,3-diol, 2-ethyl-2,4,4-trimethylcyclobutane-1,3-diol, 2,4-dimethyl-2,4-diethyl-cyclobutane-1,3-diol, 2,4-dimethyl-2,4-di-n-propylcyclobutane-1,3-diol, 2,4-n-dibutyl-2,4-diethylcyclobutane-1,3-diol, 2,4-dimethyl-2,4-diisobutylcyclobutane-1,3-diol, and 2,4-diethyl-2,4-diisoamylcyclobutane-1,3-diol. Desirably, the diol is selected from 2,2,4,4-tetraalkylcyclobutane-1,3-diol, 2,2-dimethyl-1,3-propanediol (neopentyl glycol), 1,2 cyclohexanedimethanol, 1,3-cyclohexanedimethanol, 1,4 cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 2-ethyl-2-isobutyl-1,3-propanediol, 1,3-butanediol, 1,4-butanediol, 1,5-pentanediol, 1,6-hexanediol, 2,2,4,4-tetramethyl-1,6-hexanediol, 1,10-decanediol, 1,4-benzenedimethanol, ethylene glycol, propylene glycol, diethylene glycol, dipropylene glycol, triethylene glycol, tetraethylene glycol, and polyethylene glycol, and polyols such as 1,1,1-trimethylol propane, 1,1,1-trimethylolethane, glycerin, pentaerythritol, erythritol, threitol, dipentaerythritol, sorbitol, and combinations thereof. More desirably, the diol “(a)(i)” is 2,2,4,4-tetramethylcyclobutane-1,3-diol (TMCD), 2,2-dimethyl-1,3-propanediol (neopentyl glycol), 1,2-cyclohexanedimethanol, 1,3-cyclohexanedimethanol, 1,4-cyclohexanedimethanol, 2,2,4-trimethyl-1,3-pentanediol, hydroxypivalyl hydroxypivalate, 2-methyl-1,3-propanediol, 2-butyl-2-ethyl-1,3-propanediol, 1,4-butanediol, 1,6-hexanediol and mixtures thereof.

The diols are desirably present in an amount of at least 70 mole %; or at least 75 mole %; or at least 80 mole %; or at least 85 mole %; or at least 87 mole %; or at least 90 mole %; or at least 92 mole %; wherein the diol is based on 100 mole % of all polyhydroxyl compounds. Such diols “(a)(i)” may be also be present in an amount of up to 100 mole %, or up to 98 mole %, or up to 96 mole %, or up to 95 mole %, or up to 93 mole %, or up to 90 mole %, based on 100 mole % of all polyhydroxyl compounds. Suitable ranges include, in mole % based on 100 mole % of all polyhydroxyl compounds is from: 70-100, or 75-100, or 80-100, or 85-100, or 87-100, or 90-100, or 92-100, or 95-100, or 96-100, or 70-98, or 75-98, or 80-98, or 85-98, or 87-98, or 90-98, or 92-98, or 95-93, or 96-93, or 70-93, or 75-93, or 80-93, or 85-93, or 87-93, or 90-93, or 92-93, or 70-90, or 75-90, or 80-90, or 85-90, or 87-90 mole %.

The polyhydroxyl compounds “(a)(ii)” having 3 or more hydroxyl groups can be branched or linear, saturated or unsaturated, aliphatic or cycloaliphatic C₂-C₂₀ compounds, the hydroxyl groups being primary, secondary, and/or tertiary, and desirably at least two of the hydroxyl groups are primary. Desirably, the polyhydroxyl compounds are hydrocarbons and do not contain atoms other than hydrogen, carbon and oxygen. Non-limiting examples of the polyhydroxyl compounds include 1,1,1-trimethylol propane, 1,1,1-trimethylolethane, glycerin, pentaerythritol, erythritol, threitol, dipentaerythritol, sorbitol, and mixtures thereof.

The polyhydroxyl compounds “(a)(ii)” may be present in an amount of at least 1 mole %, or at least 2 mole %, or at least 5 mole %, or at least 8 mole %, or at least 10 mole %, based on 100 mole % of all polyhydroxyl compounds “(a)”. Alternatively, the polyhydroxyl compounds “(a)(ii)” can be present in an amount of up to 30 mole %, or up to 25 mole %, or up to 20 mole %, or up to 15 mole %, or up to 13 mole %, or up to 10 mole %, or up to 8 mole %, based on 100 mole % of all polyhydroxyl compounds “(a)”. Suitable ranges of the polyhydroxyl compounds “(a)(ii)” include, in mole % based on 100 mole % of all polyhydroxyl compounds “(a)” is from: 1-30, or 2-30, or 5-30, or 8-30, or 10-30, or 1-25, or 2-25, or 5-25, or 8-25, or 10-25, or 1-20, or 2-20, or 5-20, or 8-20, or 10-20, or 1-15, or 2-15, or 5-15, or 8-15, or 10-15, or 1-13, or 2-13, or 5-13, or 8-13, or 10-13, or 1-10, or 2-10, or 5-10, or 8-10, or 1-8, or 2-8, or 5-8.

The polyhydroxyl compounds “(a)(ii)” are desirably present in an amount of at least 0.5 mole %, or at least 1 mole %, or at least 2 mole %, or at least 4 mole %, or at least 5 mole %, based on the total moles of the components of the polyester polymer. Additionally or in the alternative, the polyhydroxyl compounds “(a)(ii)” can be present in an amount of up to 15 mole %, or up to 13 mole %, or up to 10 mole %, or up to 8 mole %, or up to 6 mole %, or up to 5 mole %, or up to 4 mole %, based on the total moles of the components of the polyester polymer. Suitable ranges include, in mole % based on the total moles of the components of the polyester polymer can be from: 0.5-15, or 1-15, or 2-15, or 4-15, or 5-15, or 0.5-13, or 1-13, or 2-13, or 4-13, or 5-13, or 0.5-10, or 1-10, or 2-10, or 4-10, or 5-10, or 0.5-8, or 1-8, or 2-8, or 4-8, or 5-8, or 0.5-6, or 1-6, or 2-6, or 4-6, or 5-6, or 0.5-5, or 1-5, or 2-5, or 4-5, or 0.5-4, or 1-4, or 2-4. More desirably, the mole % of the diol “(a)(i)” is from 70 to 100, 80 to 97, or 85 to 95, and the mole % of the polyhydroxyl compound “(a)(ii)” is from 0 to 30, 3 to 20, or 5 to 15.

Alternatively, all of the polyhydroxyl compounds “(a)” used to react with the polycarboxylic compounds “(b)” are hydrocarbons, meaning that they contain only oxygen, carbon, and hydrogen. Optionally, none of the polyhydroxyl compounds “(a)” contain any ester, carboxyl (—COO—), and/or anhydride groups. Optionally, none of the polyhydroxyl compounds (a) have any carbonyl groups (—CO—). Optionally, none of the polyhydroxyl compounds (a) contain any ether groups. Desirably, the polyhydroxyl compounds (a) have from 2 to 20, or 2 to 16, or 2 to 12, or 2 to 10 carbon atoms.

The polycarboxyl compounds “(b)” contain at least polycarboxylic acid compounds, derivatives of polycarboxylic acid compounds, the anhydrides of polycarboxylic acids, or combinations thereof. The polycarboxylic acid compounds are capable of forming an ester linkage with a polyhydroxyl compound. Suitable polycarboxylic acid compounds include compounds having at least two carboxylic acid groups. For example, a polyester can be synthesized by using a polyhydroxyl compound and a derivative of a dicarboxylic acid such as, for example, dimethyl ester in or other dialkyl esters of the diacid, or diacid chloride or other diacid halides, or acid anhydride.

The polycarboxylic acid compounds can be a combination of aromatic polycarboxylic acid compounds and either or both aliphatic or cycloaliphatic polycarboxylic acid compounds. For example, the polycarboxylic acid compounds can include aromatic polycarboxylic acid compounds and aliphatic polycarboxylic acids compounds having 2 to 22 carbon atoms; or aromatic polycarboxylic acid compounds and cycloaliphatic polycarboxylic acids compounds having 2 to 22 carbon atoms; or aromatic polycarboxylic acid compounds, aliphatic polycarboxylic acids compounds having 2 to 22 carbon atoms; and cycloaliphatic polycarboxylic acids compounds having 2 to 22 carbon atoms. Examples of such polycarboxylic include those having two or more carboxylic acid functional groups or their esters. Examples of these compounds include aliphatic dicarboxylic acids, alicyclic dicarboxylic acids, aromatic dicarboxylic acids, derivatives of each, or mixtures of two or more of these acids, or the C₁-C4 ester derivatives thereof. Suitable dicarboxylic acids include, but are not limited to, isophthalic acid (or dimethyl isophthalate), terephthalic acid (or dimethyl terephthalate), phthalic acid, phthalic anhydride, 1,4 cyclohexanedicarboxylic acid, 1,3 cyclohexanedicarboxylic acid, hexahydrophthalic anhydride, tetrahydrophthalic anhydride, tetrachlorophthalic anhydride, dodecanedioic acid, sebacic acid, azelaic acid, succinic anhydride, succinic acid, adipic acid, 2,6 naphthalenedicarboxylic acid, glutaric acid, diglycolic acid; 2,5-norbornanedicarboxylic acid; 1,4-naphthalenedicarboxylic acid; 2,5-naphthalenedicarboxylic acid; diphenic acid; 4,4′-oxydibenzoic acid; 4,4′-sulfonyidibenzoic acid, and mixtures thereof.

Desirably, the polycarboxylic component includes isophthalic acid (or dimethyl isophthalate), terephthalic acid (or dimethyl terephthalate), phthalic acid, phthalic anhydride, 1,4 cyclohexanedicarboxylic acid, 1,3 cyclohexanedicarboxylic acid, adipic acid, 2,6 naphthalenedicarboxylic acid, 1,4-naphthalenedicarboxylic acid; 2,5-naphthalenedicarboxylic acid; hexahydrophthalic anhydride, tetrahydrophthalic anhydride, trimellitic anhydride, succinic anhydride, succinic acid, or mixtures thereof. Trimellitic acid or its anhydride is a useful compound to add in order to increase the acid number of the polyester if so desired.

Anhydride analogs to each of the polycarboxyl compounds described above can also be used. This would include the anhydrides of polycarboxylic acids having at least two acyl groups bonded to the same oxygen atom. The anhydrides can be symmetrical or unsymmetrical (mixed) anhydrides. The anhydrides have at least one anhydride group, and can include two, three, four, or more anhydride groups.

Specific examples of anhydrides of the dicarboxylic acids include, but are not limited to, maleic anhydride, maleic acid, fumaric acid, itaconic anhydride, itaconic acid, citraconic anhydride, citraconic acid, aconitic acid, aconitic anahydride, oxalocitraconic acid and its anhydride, mesaconic acid or its anhydride, beta-acylacrylic acid, phenyl maleic acid or its anhydride, t-butyl maleic acid or its anhydride, monomethyl fumarate, monobutyl fumarate, methyl maleic acid or its anhydride, or mixtures thereof.

The hydroxyl or carboxyl functional polyester can be prepared by any conventional process for the preparation of polyesters. For example, the polyester resin can be prepared by combining polyhydroxyl compounds “(a)” with the polycarboxyl compounds “(b)” in a reaction vessel and optionally, in the presence of an acid catalyst, at a temperature from 180−250° C. to form a reaction mixture comprising the polyester in a batch or continuous process and in one or more stages, optionally with the continuous removal of distillates and applied vacuum during at least part of the residence time.

The process for the manufacture of the polyester resin can be batchwise or continuous. The reaction of the polyhydroxyl compounds (a) and the polycarboxyl compounds (b) may be carried out in a melt phase process using conventional polyester polymerization conditions. The polyhydroxyl compounds and polycarboxylic acid compounds are combined to form a reaction mixture, and the reaction mixture is reacted in an esterification reactor at a temperature from 180-250° C. The esterification reaction many take place in one or more esterification reactors. The polyester composition can be made by a transesterification (ester interchange) reaction or by direct esterification. For example, polycarboxylic acid compounds (for direct esterification) or ester forms of the polycarboxylic acid compounds (for transesterification), and the polyhydroxyl compounds can be fed to an esterification reactor either in a combined stream, separate streams, or a combination of a combined and separate stream, and reacted at elevated temperatures, typically, from about 180° C. to about 250° C. While temperatures in excess of 250° C. can be employed, such as temperature up to 280° C., in many instances color bodies and degradation products start to form at temperatures exceeding 250° C. Desirably, the reaction mixture is reacted at any temperature within a range from about 180° C. to about 230° C. In the esterification reactor, the temperature of the reaction mixture to form the polyester intermediate composition may be static or may be increased stepwise or continuously if desired.

It is possible to start the reaction at a temperature below 210° C., or at 200° C. or less, or even at 180° C. or less, and increase the temperature over the total residence time of the reaction mixture for making the polyester intermediate composition in order to avoid generating more water by-product than the distillate collection system can efficiently remove. To assist driving the reaction of the polyhydroxyl component and acid component to completion, it is desirable to react about 1.05 to about 1.6, or 1.1-1.5, or 1.1-1.4 mole equivalents of polyhydroxyl compounds to one mole equivalent of the polycarboxylic acid compounds. A distillate can be removed from the reactor. The esterification reactor should be equipped with, and the process for making the polyester intermediate composition operated with, a distillate collection system for removing esterification or ester-exchange vapor by-products since their removal will assist with shifting the equilibrium reaction to the formation of the ester. The typical by-products formed in esterification are water in direct esterification routes, alcohols in transesterification routes, along with other reaction by-products such as aldehydes and color bodies.

The method for the removal of reaction by-products is not limited. A common method for the removal of esterification reaction by-products is a vacuum system connected to the esterification reaction zone in the reactor with a direct contact spray condenser, which is useful when a vacuum is applied to the esterification reaction zone in the esterification reactor, or a distillation column that is packed or contains trays in vapor communication with the esterification vessel for the separation of water from other reaction by-products.

The process for making the polyester resin can be conducted under a pressure within a range of 0 psig or atmospheric to about 200 psig, or from about 0 psig to about 100 psig, or from 0 psig to 40 psig. However, if desired, at least a portion or the entire residence time of the reaction to make the polyester composition can proceed under a vacuum, especially during polycondensation. If a vacuum is applied to only a portion of the residence time, it can be applied starting when at least 30%, or at least 50%, or at least 75%, or at least 80%, or at least 90% of the residence time for making the polyester resin. By applying a vacuum, the removal of water or alcohol condensate can be further enhanced, and the molecular weight Mn of the polyester can be increased. If a vacuum is applied, suitable pressures can range from 759 torr down to 0.5 torr, or 600 torr down to 0.5 torr, or 450 torr down to 0.5 torr. Vacuum can be increased with the residence time of the reaction mixture. Alternatively or in addition to the application of a vacuum, the removal of the reaction by-products can be purged or swept with an inert gas during all or a portion of the reaction. An inert gas is any gas which does not cause unwanted reaction or product characteristics at reaction conditions. Suitable gases include, but are not limited to, carbon dioxide, argon, helium, and nitrogen.

At a point when a desired Mn of the polyester resin is achieved, the compound containing the selected functionality moiety can be added to the reaction mixture containing the polyester resin. As mentioned above, the amount of the compound having a for example hydroxyl or phenolic hydroxyl moiety added to a reaction vessel can be from 3 to about 40, 3 to 30, 6 to 20, or 10 to 15 weight %, based on the weight of the reaction mixture if the polyester resin is not first isolated or based on the weight of the polyester resin if isolated. Additionally or in the alternative, the amount of compound having a desired functional moiety added to the polyester resin or reaction mixture is sufficient to consume or substitute at least 20%, or at least 30%, or at least 40%, or at least 50%, or at least 60%, or at least 70%, or at least 80%, or at least 90%, or at least 95%, or at least 99% of the hydroxyl groups on the polyester resin. Desirable, at least 70%, or at least 80%, or at least 90%, or at least 95% of the hydroxyl groups are consumed or substituted.

In addition to using the method described above, carboxyl functional polyester can also be prepared by reacting a hydroxyl functional polyester with a polycarboxylic anhydride to generate the desired number of carboxyl functionalities. In this method, the hydroxyl functional polyester is first prepared at a temperature of 180 to 250° C., and then the temperature is reduced and a polycarboxylic anhydride added for further reaction at a temperature of 140 to 180° C. Suitable polycarboxylic anhydride includes trimellitic anhydride, hexahydrophthalic anhydride, maleic anhydride, and succinic anhydride.

An acetoacetate functional polyester suitable for this invention may be prepared by reacting a polyester containing hydroxyl groups, for example, a polymer having a hydroxyl number of at least 5, preferably about 30 to 200, with an alkyl acetoacetate or diketene. Various methods for preparing an acetoacetylated polyester coating resin have been described by Witzeman et al., Journal of Coatings Technology, vol. 62, no. 789, pp. 101-112 (1990), the entire disclosure of which is incorporated herein by reference. Suitable alkyl acetoacetates for the esterification reaction with a hydroxyl-containing polyester include t-butyl acetoacetate, ethyl acetoacetate, methyl acetoacetate, isobutyl acetoacetate, isopropyl acetoacetate, n-propyl acetoacetate, and n-butyl acetoacetate.

A carbamate functional polyester suitable for this invention is a polyester having the functionality, for example illustrated as formula IV below:

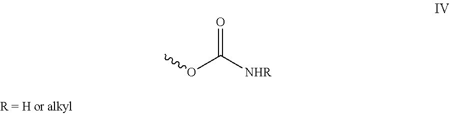

wherein R is hydrogen or an alkyl having from 2 to 22 carbon atoms.

A non-limiting example for making such as a polyester is to react a carboxyl-functional polyester with hydroxyalkyl carbamate, such as, for example, hydroxypropyl carbamate (available from Huntsman as CARBALINK® HPC). Another method for making a carbamate functional polyester is described in U.S. Pat. No. 5,508,379, the entire disclosure of which is incorporated herein by reference.

An amino functional polyester can be prepared by reacting an unsaturated polyester with ammonium or a primary amine as shown below in reaction scheme V below.

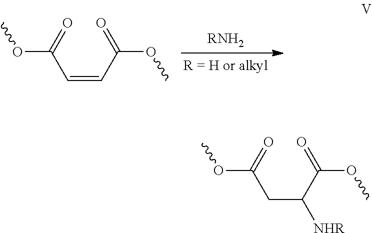

The preparation of such polyesters is disclosed in Canadian Patent Application CA2111927 (A1), the entire disclosure of which is incorporated herein by reference.

The phenol functional polyester can be prepared by reacting a hydroxyl functional polyester with p-hydroxylbenzoic acid (PHBA) or its ester such as methyl 4-hydroxybenzoate (MHB). It can also be prepared by using PHBA, MHB, 5-hydroxyisophthalic acid and mixtures thereof as one of the monomers in the polycondensation reaction when making the polyester. Either method results in the polyester having residues of phenolic functionality.

The maleimide functional polyester suitable for this invention is a polyester having the functionality illustrated below.

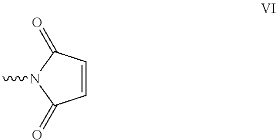

A non-limiting example for preparing such a polyester is to react a hydroxyl functional polyester with a maleimide compound having carboxyl functionality, which in turned can be prepared by reacting 4-aminobenzoic acid with maleic anhydride. Such reactions are illustrated in reaction scheme VII below:

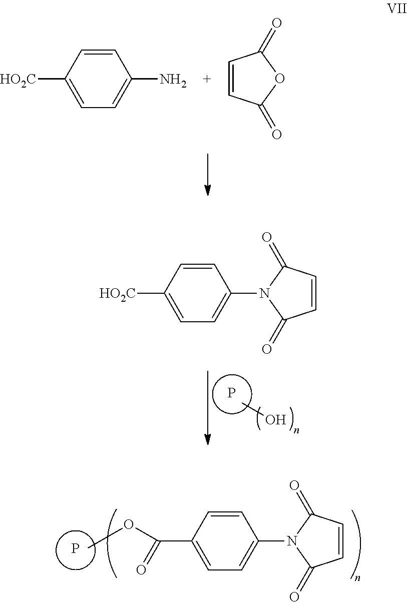

The diene functional polyester suitable for this invention can be prepared by incorporating a monomer having diene functionality into polyester. Examples of such monomers include, but not limited to, furfuryl alcohol, furoic acid, furandicarboxylic acid, bis(hydroxymethyl)furan, and unsaturated fatty acid.

The functionalized polyester can have an acid number ranging from 0 to about 120 mg KOH/g and a hydroxyl number ranging from 0 to about 300 mg KOH/g. For hydroxyl functional polyester, the hydroxyl number desirably is from about 30 to about 120 mg KOH/g. The acid number of the hydroxyl functional polyester is not particularly limited. The acid number may vary depending on the application. For example, the desirable acid number for waterborne coating application is about 50 to about 100 to impart sufficient water dispersibility after neutralization, whereas the desired acid number for solvent-based coating application is 0 to about 40, or is not more than 30, or not more than 25, or not more than 20, or not more than 15, or not more than 10, or not more than 8, or not more than 5 mg KOH/g, for better solubility and lower solution viscosity.

The acid and hydroxyl numbers are well understood by those skilled in the polyester art and are determined by titration and are reported herein as mg KOH consumed for each gram of polyester. The acid number can be measured by ASTM D1639-90 test method. The hydroxyl numbers can be measured by the ASTM D4274-11 test method.

The glass transition temperature (Tg) of the polyester of the present invention may be from −40° C. to 120° C., or from −10° C. to 100° C., or from 10° C. to 80° C., or from 10° C. to 60° C., or from 10° C. to 50° C., or from 10° C. to 45° C., or from 10° C. to 40° C., or from 20° C. to 80° C., or from 20° C. to 60° C., or from 20° C. to 50° C., or from 30° C. to 80° C., or from 30° C. to 70° C., or from 30° C. to 60° C., or from 30° C. to 50° C., or from 35° C. to 60° C. The Tg is measured on the dry polymer using standard techniques, such as differential scanning calorimetry (“DSC”), well known to persons skilled in the art. The Tg measurements of the polyesters are conducted using a “dry polymer,” that is, a polymer sample in which adventitious or absorbed water is driven off by heating to polymer to a temperature of about 200° C. and allowing the sample to return to room temperature. Typically, the polyester is dried in the DSC apparatus by conducting a first thermal scan in which the sample is heated to a temperature above the water vaporization temperature, holding the sample at that temperature until the vaporization of the water absorbed in the polymer is complete (as indicated by an a large, broad endotherm), cooling the sample to room temperature, and then conducting a second thermal scan to obtain the Tg measurement.

The number average molecular weight (Mn) of the polyester of the present invention is not limited, and may be from 1,000 to 20,000, from 1,000 to 15,000, from 1,000 to 12,500, from 1,000 to 10,000, from 1,000 to 8,000, from 1,000 to 6,000, from 1,000 to 5,000, from 1,000 to 4000, from 1,000 to 3,000, from 1,000 to 2,500, from 1,000 to 2,250, or from 1,000 to 2,000, from 1,100 to 4000, from 1,100 to 3,000, from 1,100 to 2,500, from 1,100 to 2,250, or from 1,100 to 2,000 in each case g/mole. The Mn is measured by gel permeation chromatography (GPC) using polystyrene equivalent molecular weight.

The weight average molecular weight (Mw) of the polyester can be from 1,000 to 100,000; from 1,500 to 50,000; and desirably from 2,000 to 10,000 or from 2,500 to 5,000 g/mole.

The polyester (a) can be in an amount from about 10 to 90 weight % and the benzoxazine-based phenolic resin (b) in an amount from about 10 to 90 weight %, wherein the weight % is based on the total weight of (a) and (b). Desirably, the polyester (a) is in an amount from about 50 to 80 weight % and the benzoxazine-based phenolic resin (b) in an amount from about 20 to 50 weight %.

The polyester/benzoxazine-based phenolic resin coating composition in accordance with the invention may be solvent-based, in which case the polyester and benzoxazine-based phenolic resin are dissolved or suspended in an organic solvent. Suitable organic solvents include xylene, ketones (for example, methyl amyl ketone), 2-butoxyethanol, ethyl-3-ethoxypropionate, toluene, butanol, cyclopentanone, cyclohexanone, ethyl acetate, butyl acetate, and other volatile inert solvents typically used in industrial baking (i.e., thermosetting) enamels.

Alternatively, the polyester/benzoxazine-based phenolic resin coating composition may be waterborne, which further comprises water and a neutralizing agent if necessary. The neutralizing agent may be an amine such as ammonium hydroxide, triethylamine, N,N-dimethylethanolamine, and mixtures thereof, or an inorganic base such as sodium hydroxide, potassium hydroxide, and mixtures thereof.

The polyester/benzoxazine-based phenolic resin coating composition may further include an acid or base catalyst in an amount ranging from 0.1 to 2 weight %, based on the total weight of polyester and phenolic resin. Examples of acid catalyst include protonic acids such as p-toluenesulfonic acid, dinonylnaphthalene disulfonic acid, dodecylbenzenesulfonic acid, hosphoric acid, and mixtures thereof. The acid catalyst may also be a Lewis acid or amine-blocked acid catalyst. Examples of base catalyst include an amine such as ammonium hydroxide, triethylamine, N,N-dimethylethanolamine, and mixtures thereof, and inorganic base such as sodium hydroxide, potassium hydroxide, and combinations thereof.

In another aspect, the invention provides a thermosetting coating composition having the above described polyester/benzoxazine-based phenolic resin and further comprising one or more cross-linking catalysts. Examples of such catalysts include p-toluenesulfonic acid, the NACURE™ 155, 5076, and 1051 catalysts sold by King Industries, BYK 450, 470, available from BYK-Chemie U.S.A., p-toluenesulfonamide, and combinations thereof.

The polyester/benzoxazine-based phenolic resin coating composition of this invention may further comprise a conventional crosslinker known to those skilled the art of coating applications, such as, for example, aminoplast, phenolplast, isocyanate, epoxy crosslinkers and combinations thereof.

In addition to the composition be used as a coating application, the thermosetting composition can also be used for other applications where forming a polymeric network is desirable, such as in an adhesive, in a plastic molding, or in rubber compounding, in which case the composition may further comprise natural rubber, synthetic rubber, or a combination thereof.

Another aspect of the present invention, there is provided a coating composition as described above, further comprising one or more leveling, rheology, and flow control agents such as silicones, fluorocarbons or cellulosics; flatting agents; pigment wetting and dispersing agents; surfactants; ultraviolet (UV) absorbers; UV light stabilizers; tinting pigments; defoaming and antifoaming agents; anti-settling, anti-sag and bodying agents; anti-skinning agents; anti-flooding and anti-floating agents; fungicides and mildewicides; corrosion inhibitors; thickening agents; coalescing agents and combinations thereof. Specific examples of such additives can be found in Raw Materials Index, published by the National Paint & Coatings Association, 1500 Rhode Island Avenue, N.W., Washington, D.C. 20005.

After formulation, the coating composition can be applied to a substrate or article. Thus, a further aspect of the present invention is a shaped or formed article that has been coated with the coating compositions of the present invention. The substrate can be any common substrate such as paper; polymer films such as polyethylene or polypropylene; wood; metals such as aluminum, steel or galvanized sheeting; glass; urethane elastomers; primed (painted) substrates; and the like. The coating composition can be coated onto a substrate using techniques known in the art, for example, by spraying, draw-down, roll-coating, etc., to form a dried coating having a thickness of about 0.1 to about 4 mils (1 mil=25 μm), or 0.5 to 3, or 0.5 to 2, or 0.5 to 1 mils on the substrate. The coating can be cured by heating to a temperature of about 150° C. to about 230° C., or from 160° C. to 200° C., for a time period that typically ranges about 5 to about 90 minutes. Afterwards, the coating and substrate are allowed to cool.

The present invention is illustrated in greater detail by the specific examples presented below. It is to be understood that these examples are illustrative and are not intended to be limiting of the invention, but rather are to be construed broadly within the scope and content of the appended claims. All parts and percentages in the examples are on a weight basis unless otherwise stated.

### Comparative Example 1

### Control 1

### Synthesis of Benzoxazine Based on m-Xylylenediamine (Mole Ratio of Phenol/Amine/HCHO=2/1/4)

A 500 mL, three-neck, round-bottom flask equipped with a mechanical stirrer, a nitrogen inlet, a Dean-Stark trap, and a water condenser was charged with 21.6 grams (g) of m-cresol (0.20 moles), 12.0 g of paraformaldehyde (0.40 moles of HCHO), and 100 g of toluene. To this stirred mixture was added 13.6 g m-xylylenediamine (0.10 moles). The temperature was raised to 90° C. over a period of about 30 minutes at a rate of about 2° C. per minute. The mixture was allowed to react under a nitrogen atmosphere at 90° C. for 2.5 hours, then at 95° C. for 25 minutes. The condensate (water, 5 mL) and organic volatiles (27 mL) were collected in the Dean-Stark trap. The temperature was then raised to 110° C. to distill off more of the volatiles. The distillation was stopped when a total of 81 mL of the organic layer was collected. The remaining reaction mixture was allowed to cool and collected. The yield was 59.7 g (67% solids).

### Comparative Example 2

### Control 2

### Synthesis of Benzoxazine Based on 2-Methylpentamethylenediamine (Mole Ratio of Phenol/Amine/HCHO=2/1/4)

A 500 mL, three-neck, round-bottom flask equipped with a mechanical stirrer, a nitrogen inlet, a Dean-Stark trap, and a water condenser was charged with 32.4 g of m-cresol (0.30 moles), 18.0 g of paraformaldehyde (0.60 moles of HCHO), and 80 g of toluene. To this stirred mixture was added 17.4 g methylpentamethylenediamine (0.15 moles; Dytek A amine available from INVISTA). The temperature was raised 25 to 90° C. over a period of about 30 minutes at a rate of about 2° C. per minute. The mixture was allowed to react under a nitrogen atmosphere as follows: at 90° C. for two hours; then at 95° C. for 30 minutes; then at 100° C. for two hours; at 110° C. for 20 minutes; and at 115° C. for 25 minutes. The distillate was collected in the Dean-Stark trap during the reaction. A total amount of 70 mL (the condensate (water, 9 mL) and organic volatiles, (61 mL)) was collected. The remaining reaction mixture was allowed to cool and collected. The yield was 75.6 g (75% solids).

### Example 1

### Synthesis of Benzoxazine Based on Diethylenetriamine (Mole Ratio of Phenol/Amine/HCHO=2/1/5)(BZ-1)

A 500 mL, three-neck, round-bottom flask equipped with a mechanical stirrer, a nitrogen inlet, a Dean-Stark trap, and a water condenser was charged with 32.4 g of m-cresol (0.30 moles), 22.50 g of paraformaldehyde (0.75 moles HCHO), and 80 g of toluene. To this stirred mixture was added 15.45 g diethylenetriamine (0.15 moles). The temperature was raised to 90° C. over a period of about 30 minutes at a rate of about 2° C. per minute. The mixture was allowed to react under a nitrogen atmosphere as follows: at 90° C. for one hour; then at 95° C. for one hour; then at 100° C. for 2.5 hours; at 110° C. for 45 minutes; and at 115° C. for 30 minutes. The distillate was collected in the Dean-Stark trap during the reaction. A total amount of 72 mL (the condensate (water, 11 mL) and organic volatiles, (61 mL)) was collected. The remaining reaction mixture was allowed to cool and collected. The yield was 71.7 g (84% solids).

### Example 2

### Synthesis of Benzoxazine Based on Diethylenetriamine (Mole Ratio of Phenol/Amine/HCHO=2/1/4) (BZ-2) in Tolune

A 500 mL, three-neck, round-bottom flask equipped with a mechanical stirrer, a nitrogen inlet, a Dean-Stark trap, and a water condenser was charged with 32.4 g of m-cresol (0.30 moles), 18.00 g of paraformaldehyde (0.60 moles of HCHO), and 80 g of toluene. To this stirred mixture was added 15.45 g diethylenetriamine (0.15 moles). The temperature was raised to 80° C. over a period of about 30 minutes at a rate of about 2° C. per minute. The mixture was allowed to react under a nitrogen atmosphere as follows: at 80° C. for 35 minutes; then at 95° C. for 90 minutes; then at 100° C. for 2.5 hours; and at 110° C. for 90 minutes. The distillate was collected in the Dean-Stark trap during the reaction. A total amount of 70 mL (the condensate (water, 9 mL) and organic volatiles, (61 mL)) was collected. The remaining reaction mixture was allowed to cool and collected. The yield was 69.7 g (85%) solids.

### Example 3

### Synthesis of Benzoxazine Based on Diethylenetriamine (Mole Ratio of Phenol/Amine/HCHO=2/1/4) (BZ-3) in n-Butanol

A 500 mL, three-neck, round-bottom flask equipped with a mechanical stirrer, a nitrogen inlet, a Dean-Stark trap, and a water condenser was charged with 32.4 g of m-cresol (0.30 moles), 18.00 g of paraformaldehyde (0.60 moles of HCHO), and 70 g of n-butanol. To this stirred mixture was added 15.45 g diethylenetriamine (0.15 moles). The temperature was raised to 90° C. over a period of about 30 minutes at a rate of about 2° C. per minute. The mixture was allowed to react under a nitrogen atmosphere as follows: at 90° C. for 60 minutes and then at 95° C. for 90 minutes. The distillate was collected in the Dean-Stark trap during the reaction. A total amount of 29 mL (the condensate (water, 7.5 mL) and organic volatiles, (21.5 mL)) was collected. The remaining reaction mixture was allowed to cool and collected. The yield was 109.4 g. An amount of 11.5 g methyl amyl ketone (MAK) was added to the resulting mixture to improve the solution clarity (50% solids).

### Example 4

### Self-Curing Evaluation for the Various Benzoxazines

Formulations 1-4 were prepared as indicated in Table 1 below, by adding toluene and p-toluenesulfonic acid (pTSA, 5% in isopropanol), if used, to benzoxazine prepared in Examples 1 and 2 (BZ-1 and BZ-2). The formulations were drawn down on cold-rolled steel test panels (ACT 3×9×032 from Advanced Coating Technologies) using a draw-down bar and subsequently baked in an oven at 205° C. for 10 minutes to yield cured films having a thickness of about 20 microns. The degree of crosslinking of the cured films was determined by the solvent resistance using MEK Double Rub Method (ASTM D4752). The results are presented in Table 1, where phr denotes parts per hundred of resin. Typically a result of >200 double rubs indicates a film is fully cured.

TABLE 1

| | | | MEK double | MEK double |
|---|---|---|---|---|
| | | Catalyst | rubs, cured | rubs, cured |
| Formu- | Benzoxazine | (pTSA, 5% in | at 205° C. for | at 160° C. for |
| lation | solution | isopropanol) | 10 min. | 30 min. |
| 1 | BZ-1 (50% | 0 | no effect at 500 | no effect at 500 |
| | in toluene) | | (yellow) | (litter color) |
| 2 | BZ-1 (50% | 0.5 phr | no effect at 500 | no effect at 500 |
| | in toluene) | | (yellow) | (litter color) |
| 3 | BZ-2 (60% | 0 | no effect at 500 | no effect at 500 |
| | in toluene) | | (yellow) | (litter color) |
| 4 | BZ-2 (60% | 0.5 phr | no effect at 500 | no effect at 500 |
| | in toluene) | | (yellow) | (litter color) |

### Example 5

### Synthesis of Unsaturated Polyester (PE-1)

A 500 mL, three-neck, round-bottom flask was equipped with a mechanical stirrer, a heated partial condenser, a Dean-Stark trap, and a water condenser was charged with 42.34 g of 2,2,4,4-tetramethylcyclobutane-1,3-diol (TMCD) (0.294 mole); 30.55 g of neopentyl glycol (NPG) (0.294 mole); 29.55 g of isophthalic acid (IPA) (0.178 mole); 0.22 g of the acid catalyst, Fascat-4100 (available from Arkema Inc.); and 0.58 g of the stabilizer, VANSTAY SC (TIOP) (available from Vanderbilt Chemicals). The mixture was allowed to react under nitrogen atmosphere as follows: at 180° C. for 40 minutes; at 200° C. for 85 minutes, and then at 220° C. for 90 minutes, to yield a clear, viscous product. The resulting product was allowed to cool to 170° C., before 17.47 g of maleic anhydride (0.178 mole) was added as a second stage reactant. The reaction was allowed to continue at 220° C. for 25 minutes, then at 230° C. for 90 minutes. The product was a clear, viscous resin. A total of 16 mL of distillate was collected in the Dean-Stark trap. The resulting clear resin was allowed to cool to room temperature and subsequently collected. The product resin had an acid number of 6.2 mgKOH/g; a hydroxyl number of 39.0 mgKOH/g; a glass transition temperature (Tg) of 16.3° C.; a number average molecular weight (Mn) of 3382; and a weight average molecular weight (Mw) of 8277.

### Example 6

### Preparation of Formulations Using Unsaturated Polyester (PE-1) and Various Benzoxazines

Formulations 5-8 were prepared as indicated in Table 2 below, by using maleic functional polyester (PE-1) and various benzoxazines prepared previously. Polyester solution (35% solids, based on the total weight of the polyester and xylene) was first prepared by dissolving the polyester in xylene. Each of the four formulations was prepared by mixing the polyester solution with benzoxazine solutions in xylene. Each solution contained: 7.14 grams of PE-1 solution (35% solides); 1 gram of an acid catalyst, p-toluenesulfonic acid (pTSA—5 weight % in isopropanol); a resin ratio of 50/50 (based on PE to benzoxazine); and a catalyst ratio of 1 part per hundred of resin, polyester and benzoxazine (phr).

TABLE 2

| Formulation | Benzoxazine (grams) |
|---|---|
| 5 | 3.73 (control 1 - 67% in toluene) |
| 6 | 3.33 (control 2 - 75% in toluene) |
| 7 | 5.00 (BZ-1 - 50% in toluene) |
| 8 | 4.12 (BZ-2 - 60% in toluene) |

### Comparative Example 7

### Evaluation of Cured Films by MEK Double Rub Test

Formulations 5-8 prepared in Example 6 were drawn down on cold-rolled steel test panels (ACT 3×9×032 from Advanced Coating Technologies) using a drawn-down bar and subsequently baked in an oven at 205° C. for 10 minutes to yield cured films having a thickness of about 20 microns. The degree of crosslinking of the cured films was determined by their solvent resistance using MEK Double Rub Method (ASTM D4752). All formulations had a Double Rub result of less than 20 indicating a low crosslinking of the polyester having an ethylenically unsaturated functionality with the various prepared benzoxazines.

### Example 8

### Synthesis of Phenol Functional Polyester (PE-2)

### Step 1: Preparation of Hydroxyl Functional Polyester.

A 500 mL, three-neck, round-bottom flask was equipped with a mechanical stirrer, a heated partial condenser, a Dean-Stark trap, and a water condenser was charged with 376.9 grams of 2,2,4,4-tetramethylcyclobutane-1,3-diol (TMCD) (2.614 mole), 16.66 g of trimethylolpropane (TMP) (0.124 mole); 232.6 g of isophthalic acid (IPA) (1.400 mole); 87.7 g of adipic acid (AD) (0.600 mole), and 1.07 g of an acid catalyst, Fascat-4100 (available from Arkema Inc.). The mixture was allowed to react under a nitrogen atmosphere as follows: at 180° C. for 30 minutes; at 200° C. for 45 minutes; at 220° C. for 90 minutes; and at 230° C. for about 2 hours to yield a clear, viscous product. A total of 72.5 mL of distillate was collected in the Dean-Stark trap. The product resin had an acid number of 0 mgKOH/g; a hydroxyl number of 113 mgKOH/g; a glass transition temperature (Tg) of 39.2° C.; a number average molecular weight (Mn) of 1459; and a weight average molecular weight (Mw) of 2673.

### Step 2: Preparation of Phenol Functional Polyester (PE-2).

A part of the above hydroxyl functional polyester was used for making the phenol functional polyester. To a 500 mL flask equipped as above were added 50.00 g of the hydroxyl functional polyester, 10.17 g of methyl-4-hydroxybenzoate (0.067 moles), and 0.09 g of a catalyst Fascat 4100 (available from Arkema, Inc.). The mixture as allowed to react under a nitrogen atmosphere as follows: at 190° C. for 60 minutes; at 200° C. for 90 minutes; and at 220° C. for 90 minutes to yield a clear, viscous resin. The resulting resin was allowed to cool to room temperature and collected. The product resin had a glass transition temperature (Tg) of 54.3° C.; a number average molecular weight (Mn) of 1361; and a weight average molecular weight (Mw) of 3378.

### Example 9

### Preparation of Formulations Using Phenol Functional Polyester and Various Benzoxazines

Formulations 9-12 were prepared as indicated in Table 3 below, by using the phenol functional polyester (PE-2) and various benzoxazines prepared previously. Polyester solutions (35% solids based on the total weight of the polyester and xylene) were first prepared by dissolving the polyester in xylene. Each of the four formulations was prepared by mixing the polyester solution with benzoxazine solutions in xylene. Each solution contained: 7.14 grams of PE-2 solution (35% solids); 1 gram of an acid catalyst, p-toluenesulfonic acid (pTSA—5 weight % in isopropanol—how is weight % determined); a resin ratio of 50/50 (based on PE to benzoxazine) and a catalyst ratio of 1 phr.

TABLE 3

| Formulation | Benzoxazine (grams) |
|---|---|
| 9 | 3.73 (control 1 - 67% in toluene) |
| 10 | 3.33 (control 2 - 75% in toluene) |
| 11 | 5.00 (BZ-1 - 50% in toluene) |
| 12 | 4.12 (BZ-2 - 60% in toluene) |

### Example 10

### Evaluation of Cured Films by MEK Double Rub Test

Formulations 9-12 prepared in Example 9 were drawn down on cold-rolled steel test panels (ACT 3×9×032 from Advanced Coating Technologies) using a drawn-down bar and subsequently baked in an oven at 205° C. for 10 minutes to yield cured films having a thickness of about 20 microns. The degree of crosslinking of the cured films was determined by their solvent resistance using MEK Double Rub Method (ASTM D4752). The results are in Table 4 below.

TABLE 4

| Formulation | MEK double rub |
|---|---|
| 9 | Less than 20 |
| 10 | 20 slight effect |
| 11 | 200 slight effect |
| 12 | 100 moderate effect |

### Example 11

### Synthesis of Carboxyl-Functional Polyester (PE-3)

A 500 mL, three-neck, round-bottom flask was equipped with a mechanical stirrer, a heated partial condenser, a Dean-Stark trap, and a water condenser was charged with 50.6 g neopentyl glycol (NPG) (0.49 moles); 6.66 g trimethylolpropane (TMP) (0.05 moles); 46.5 g isophthalic acid (IPA) (0.28 moles); 17.5 g adipic acid (AD) (0.12 moles); and 0.18 g of the acid catalyst, Fascat-4100 (available from Arkema Inc.). The mixture was allowed to react under a nitrogen atmosphere as follows: at 180° C. for 30 minutes; at 200° C. for 60 minutes; at 220° C. for 100 minutes; and at 230° C. for about 2 hours, to yield a clear, viscous mixture. A total of 13 mL of distillate was collected in the Dean-Stark trap.

The reaction mixture was then allowed to cool to 150° C. To the 500 mL flask 14.06 g of trimellitic anhydride (TMA) (0.067 moles) was added. After the addition of TMA, the temperature was increased to 170° C. at a rate of about 2° C. per minute and the mixture allowed to react for about 1.5 hours. The resulting mixture was allowed to cool to room temperature and subsequently placed in dry ice to chill for ease to break and collect the solid product (115.5 g). The product resin had an acid number of 58 mgKOH/g; a hydroxyl number of 49 mgKOH/g; a glass transition temperature (Tg) of 30.8° C.; a number average molecular weight (Mn) of 1996; and a weight average molecular weight (Mw) of 6402.

### Example 12

### Preparation of Formulations Using Carboxyl Functional Polyester (PE-3) and Various Benzoxazines

Formulations 13-15 were prepared as indicated in Table 5 below, by using the carboxy functional polyester (PE-3) and various benzoxazines prepared previously. Polyester solution (35% solids, based on the total weight of the polyester and the solvent) was first prepared by dissolving the polyester in methyl amyl ketone (MAK). Each of the three formulations was prepared by mixing the polyester solution with benzoxazine solutions in xylene in the presence of an acid catalyst. Each formulation had 1 gram of the acid catalyst, p-toluenesulfonic acid (pTSA—5 weight % in isopropanol) and a catalyst ratio of 1 phr.

TABLE 5

| | Polyester | | |
|---|---|---|---|
| | (35% in | | Resin |
| Formulation | MAK) grams | Benzoxazine (grams) | Ratio |
| 13 | 7.14 | 3.33 (control 2 - 75% in toluene) | 50/50 |
| 14 | 7.14 | 5.00 (BZ-3 - 50% in n-butanol/MAK) | 50/50 |
| 15 | 10 | 3.00 (BZ-3 - 75% in toluene) | 70/30 |

### Example 13

### Evaluation of Cured Films by MEK Double Rub Test

Formulations 13-15 prepared in Example 12 were drawn down on cold-rolled steel test panels (ACT 3×9×032 from Advanced Coating Technologies) using a drawn-down bar and subsequently baked in an oven at 205° C. for 10 minutes to yield a cured film having a thickness of about 20 microns. The degree of crosslinking of the cured films was determined by their solvent resistance using MEK Double Rub Method (ASTM D4752). The results are in Table 6 below.

TABLE 6

| Formulation | MEK double rub |
|---|---|
| 13 | Less than 10 |
| 14 | 500 |
| 15 | 100 |

### Example 14

### Synthesis of Hydroxyl Functional Polyester (PE-4)

A 500 mL, three-neck, round-bottom flask was equipped with a mechanical stirrer, a heated partial condenser, a Dean-Stark trap, and a water condenser was charged with 226.2 g 2,2,4,4-tetramethylcyclobutane-1,3-diol (TMCD) (1.57 moles); 9.99 g of trimethylolpropane (TMP) (0.075 moles); 199.4 g of isophthalic acid (IPA) (1.20 moles); and 0.65 g of the acid catalyst, Fascat-4100 (available from Arkema Inc.). The mixture was allowed to react under a nitrogen atmosphere as follows: at 180° C. for 20 minutes; at 200° C. for 90 minutes; at 220° C. for 2 hours; and at 230° C. for about 3 hours, to yield a clear, viscous mixture. A total of 46 mL of distillate was collected in the Dean-Stark trap. The resulting mixture was allowed to cool to room temperature and collected (355.5 g). The product resin had an acid number of 4.8 mgKOH/g; a hydroxyl number of 102 mgKOH/g; a glass transition temperature (Tg) of 79.7° C.; a number average molecular weight (Mn)) of 1616; and a weight average molecular weight (Mw) of 3171.

### Example 15

### Preparation of Formulations Using Hydroxyl Functional Polyester (PE-4) and Various Benzoxazines

Formulations 16-19 were prepared as indicated in Table 7 below, by using the hydroxyl functional polyester (PE-4) and various benzoxazines prepared previously. Polyester solutions (35% solids) were first prepared by dissolving the polyester in xylene. Each of the four formulations was prepared by mixing the polyester solution with benzoxazine solutions in xylene in the presence of an acid catalyst. Each formulation had 1 gram of the acid catalyst, p-toluenesulfonic acid (pTSA—5 weight % in isopropanol) and a catalyst ratio of 1 phr.

TABLE 7

| | Polyester | | |
|---|---|---|---|
| | (35% in | | Resin |
| Formulation | MAK) grams | Benzoxazine (grams) | Ratio |
| 16 | 7.14 | 3.73 (control 1 - 67% in toluene) | 50/50 |
| 17 | 7.14 | 3.33 (control 2 - 75% in toluene) | 50/50 |
| 18 | 7.14 | 5.00 (BZ-1 - 50% in toluene) | 50/50 |
| 19 | 10 | 3.00 (BZ-2 - 60% in toluene) | 70/30 |

### Example 16

### Evaluation of Cured Films by MEK Double Rub Test

Formulations 16-19 prepared in Example 15 were drawn down on cold-rolled steel test panels (ACT 3×9×032 from Advanced Coating Technologies) using a drawn-down bar and subsequently baked in an oven at 205° C. for 10 minutes to yield cured films having a thickness of about 20 microns. The degree of crosslinking of the cured films was determined by their solvent resistance using MEK Double Rub Method (ASTM D4752). The results are in Table 8 below.

TABLE 8

| Formulation | MEK double rub |
|---|---|
| 16 | Less than 20 |
| 17 | Less than 20 |
| 18 | 100* |
| 19 | 100* |

*Film became discolored and tacky but remained intact at 100.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

1-21. (canceled)

22. A thermosetting coating composition comprising the reaction product of:
(a)
(i) a polyester having an acid number ranging from 0 to 120 mg KOH/g, and a hydroxyl number from about 30 to about 120 mg KOH/g; or
(ii) a phenol-functional polyester; or a mixture thereof; and
(b) a benzoxazine-based phenolic resin, comprising the reaction product of (i) a phenol compound, (ii) an aldehyde, and (iii) a polyamine having at least one primary amine and at least one secondary amine.

23. The coating composition of claim 22, wherein the polyamine is represented by the general formula: H₂N-A-[NH—B]ₙ—NH₂, where A and B are independently selected from linear or branched hydrocarbon radicals having from 2 to 4 carbon atoms and n is an integer of from 1 to 4.

24. The coating composition of claim 22 wherein the polyamine is selected from the group consisting of diethylenetriamine, tetraethylenepentamine, bis(hexamethylene)triamine, H₂N—(CH₂)₄—NH—(CH₂)₃—NH₂ (spermidine), H₂N—(CH₂)₃—NH—(CH₂)₄—NH—(CH₂)₃—NH₂ (spermine) and mixtures thereof.

25. The coating composition of claim 22 wherein the polyamine is diethylenetriamine.

26. The coating composition of claim 22 wherein the phenol compound is selected from the group comprising phenol, m-cresol, m-ethylphenol, m-propylphenol, m-butylphenol, m-octylphenol, m-phenylphenol, 3,5-xylenol, 3,5-diethyl phenol, 3,5-dibutyl phenol, 3,5-dialkylphenol, 3,5-dicyclohexyl phenol, 3,5-dimethoxy phenol and mixtures thereof.

27. The coating composition of claim 22 wherein the aldehyde is formaldehyde.

28. The coating composition of claim 22 wherein the phenol compound is phenol or m-cresol, the aldehyde is formaldehyde, and the polyamine is diethylenetriamine.

29. The coating composition of claim 22, wherein the polyester (a) is in an amount from about 10 to 90 weight % and the benzoxazine-based phenolic resin (b) in an amount from about 10 to 90 weight %, wherein the weight % is based on the total weight of (a) and (b).

30. The coating composition of claim 22, wherein the polyester (a) is present in an amount from about 50 to 80 weight % and the benzoxazine-based phenolic resin (b) is present in an amount from about 20 to 50 weight %, wherein the weight % is based on the total weight of (a) and (b).

31. The coating composition of claim 22, further comprising an aminoplast crosslinker.
